(19) United States
(12) Patent Application Publication
(10) Pub. No.: US 2012/0216136 A1
(43) Pub. Date: Aug. 23, 2012

(54) APPLICATION-INDEPENDENT GRAPHIC MANIPULATION

(75) Inventor: Christopher K. Karstens, Apex, NC (US)

(73) Assignee: International Business Machines Corporation, Armonk, NY (US)

(21) Appl. No.: 13/030,903

(22) Filed: Feb. 18, 2011

(51) Int. Cl. G06F 3/048

(52) U.S. Cl. 715/765

(57) ABSTRACT

Embodiments include a method comprising displaying, on a computer display, a window having a user interface for an application. The window has a number of elements. The elements comprising at least one of text, a graphical icon, and input control. The window is configurable to receive user input for processing by the application. The method includes receiving, independent of the application, an input for graphic manipulation of the computer display of at least some of the number of elements in the window. The method includes updating, independent of the application, at least some of the number of elements, based on the graphic manipulation. The method also includes displaying, on the computer display, an updated window having the number of elements updated based on the graphic manipulation, wherein the updated window is configurable to receive user input for processing by the application.

### BACKGROUND

Embodiments of the inventive subject matter generally relate to the field of computers, and, more particularly, to application-independent graphic manipulation.

Graphical User Interfaces (GUIs) can provide an interface for a number of different applications having differences in text, graphics, icons, buttons, controls etc. For example, different application interfaces can have varying sizes, colors, fonts, etc.

### SUMMARY

Embodiments include a method comprising displaying, on a computer display, a window having a user interface for an application. The window has a number of elements. The elements comprising at least one of text, a graphical icon, and input control. The window is configurable to receive user input for processing by the application. The method includes receiving, independent of the application, an input for graphic manipulation of the computer display of at least some of the number of elements in the window. The method includes updating, independent of the application, at least some of the number of elements, based on the graphic manipulation. The method also includes displaying, on the computer display, an updated window having the number of elements updated based on the graphic manipulation, wherein the updated window is configurable to receive user input for processing by the application.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a conceptual diagram of a system to enable graphic manipulation of elements in windows displaying graphic output of applications, independent of the applications, according to some example embodiments.

FIG. 2 depicts a screenshot of a window prior to a graphic manipulation, according to some example embodiments.

FIG. 3 depicts a screenshot of the window of FIG. 2 after a graphic manipulation wherein the window is scaled to an enlarged size, according to some example embodiments.

FIG. 4 depicts a screenshot of the window of FIG. 2 after a graphic manipulation wherein the window size remains the same but contents within the window frame are scaled to an enlarged size, according to some example embodiments.

FIG. 5 depicts a screenshot of the window of FIG. 2 after a graphic manipulation wherein the window is rotated, according to some example embodiments.

FIG. 6 depicts a screenshot of the window of FIG. 2 after a graphic manipulation wherein the window is made taller and thinner, according to some example embodiments.

FIG. 7 depicts a screenshot of the window of FIG. 2 after a graphic manipulation wherein the colors in the window are inverted, according to some example embodiments.

FIG. 8 depicts a screenshot of the window of FIG. 2 after a graphic manipulation wherein the window is tilted backwards, according to some example embodiments.

FIG. 9 depicts a flowchart to perform graphic manipulation of elements in windows displaying graphic output of applications, independent of the applications, according to some example embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

Some example embodiments can be used in a windows-based configuration, wherein different applications can their display output in different windows on a computer display. These different windows provide a graphical user interface for the applications. For example, a word processor application can display its output in a first window of a computer display; a spreadsheet application can display its output in a second window of the computer display; an Internet web browser application can display its output in a third window of the computer display, etc. Each application can display its own sizing of the different elements therein (e.g., text, graphics, icons, buttons, controls, etc.). In such a configuration, some applications can display window elements too small and other applications can display window elements too large for a user's needs.

Some example embodiments perform graphic manipulation of the elements of a window that is displaying output from an application, without or independent of the application itself In some example embodiments, a graphics manager that is part of an operating system of the computer is controlling this graphic manipulation. Such embodiments are particularly useful in today's computing environments where application programmers of diverse skill levels are now creating applications. Those persons now producing applications are not just limited to big corporate entities. In particular, because of the software tools now available, a person with a minimum knowledge base can create applications for use by a large number of consumers. For example, an individual person working out of his house can now easily create applications for mobile devices, desktop computers, etc. Because of this large diversity of persons creating applications, the display of some applications may not be appropriate for some of the consumers and/or computing environments. For example, the display of some applications can be too large in some computing environments, too small in other computing environments, etc. Accordingly, some example embodiments provide for graphics manipulation of some or all parts of the window display of any number of different applications, independent of the applications themselves. In other words, the applications are unaware of these graphic manipulations.

Therefore in some example embodiments, the graphic manipulation is occurring at a window management level (and not by the individual applications whose data is being displayed in different windows). For example, a user can request different graphic manipulations of a window. In response, a graphics manager can remap or transform the elements in the window in real time. The graphics manager can scale, distort, show perspective, rotate, make wider, make taller, modify colors, invert colors, etc. The resulting scaled and/or modified windows are normal windows that a user can interact with, input text, select input controls (e.g., buttons), maximize, minimize, etc. In other words, the graphical user interface abilities of the applications are maintained prior to, during and after the graphic manipulations.

Some example embodiments enable automatically scaling of elements in a window on a per element basis and/or on a per window basis. In some example embodiments, the graphic manipulation of the elements is maintained until the application is closed. In some other example embodiments, the graphic manipulation of the elements for an application is persistent. Accordingly, this graphic manipulation can be used for subsequent instantiations of the application. Also, the graphic manipulation of the elements of an application can be used for any future children elements. For example, a popup window created from an application can be automatically scaled based on the scaling of the elements in the application.

In some example embodiments, graphic manipulation can occur for elements within a window frame but not for the window frame itself. Alternatively, graphic manipulation can also affect the window frame itself (including the title text, window controls, etc.). A minimum scale can also be enforced to prevent elements from being too small to see or control. Similarly, the maximum scale can be enforced to prevent elements from being too large to see or control. Also, scaling can default to maintain element proportions. For example, an application having a square window is required to remain square as part of the scaling. Alternatively, scaling can be manual. For example, an application having a square window can be scaled to a vertical rectangle, horizontal rectangle, etc.

Accordingly, users are no longer required to use applications that force elements to be displayed too large, too small, etc. Also, users are not required to use auxiliary magnification tools to modify elements/windows of applications. Using example embodiments, users can perform custom graphic manipulation (e.g., scaling) for each and every element/window independently of one another for a better viewing experience.

Some example embodiments can be incorporated with auto zooming operations. For example, new applications that are subsequently installed can automatically autoscale based on the user's element preferences. To illustrate, a user can rank text as most important, rank graphics as the next most important after text, rank buttons as the next most important after graphics, etc. The autoscaling operations can determine what type of data is being displayed and make adjustments automatically to this data based on the rankings provided by the user. As further described below in some example embodiments, the graphics manipulation can include adding and removing of three dimensional (3D) content from elements in the windows.

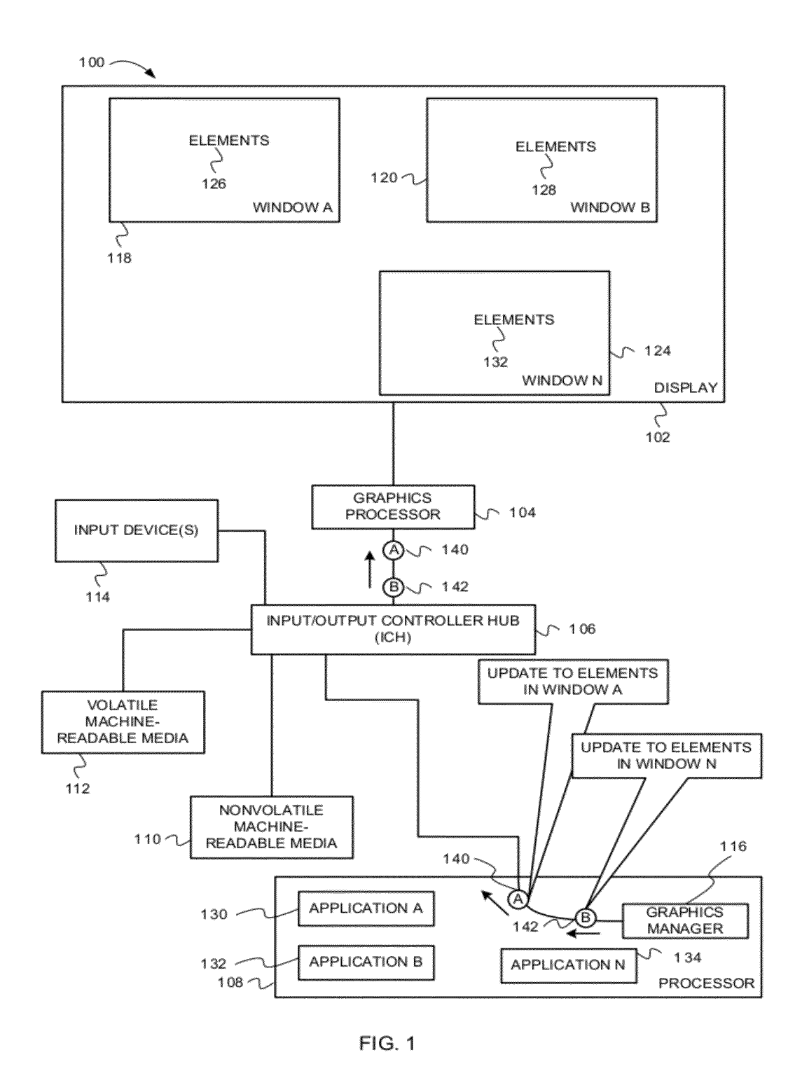

FIG. 1 depicts a conceptual diagram of a system to enable graphic manipulation of elements in windows displaying graphic output of applications, independent of the applications, according to some example embodiments. FIG. 1 can represent any type of computing device (e.g., a desktop computer, laptop computer, mobile device, etc.). Also the components of FIG. 1 can be in a single device or distributed across two or more devices. FIG. 1 includes a system 100 that includes a display 102, a graphics processor 104, an input/output (I/O) controller hub 106, a processor 108, a nonvolatile machine-readable media 110, a volatile machine-readable media 112, and input device(s) 114.

The I/O controller hub 106 is communicatively coupled to the graphics processor 104, the input device(s) 114, the volatile machine-readable media 112, the nonvolatile machine-readable media 110, and the processor 108. The graphics processor 104 is communicatively coupled to the display 102. The processor 108 can be one processor or possibly multiple processors, multiple cores, multiple nodes, and/or implementing multi-threading, etc. The volatile machine-readable media 112 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. Although illustrated as being coupled to the I/O controller hub 106, the volatile machine-readable media 112 may be coupled to the processor 108. The nonvolatile machine-readable media 110 can include optical storage, magnetic storage, etc. The input device(s) 114 can include a keyboard, mouse, microphone, etc. The system 100 can include other components not shown in FIG. 1. For example, the system 100 can include a network interface (e.g., an ATM interface, an Ethernet interface, a Frame Relay interface, SONET interface, wireless interface, etc.)

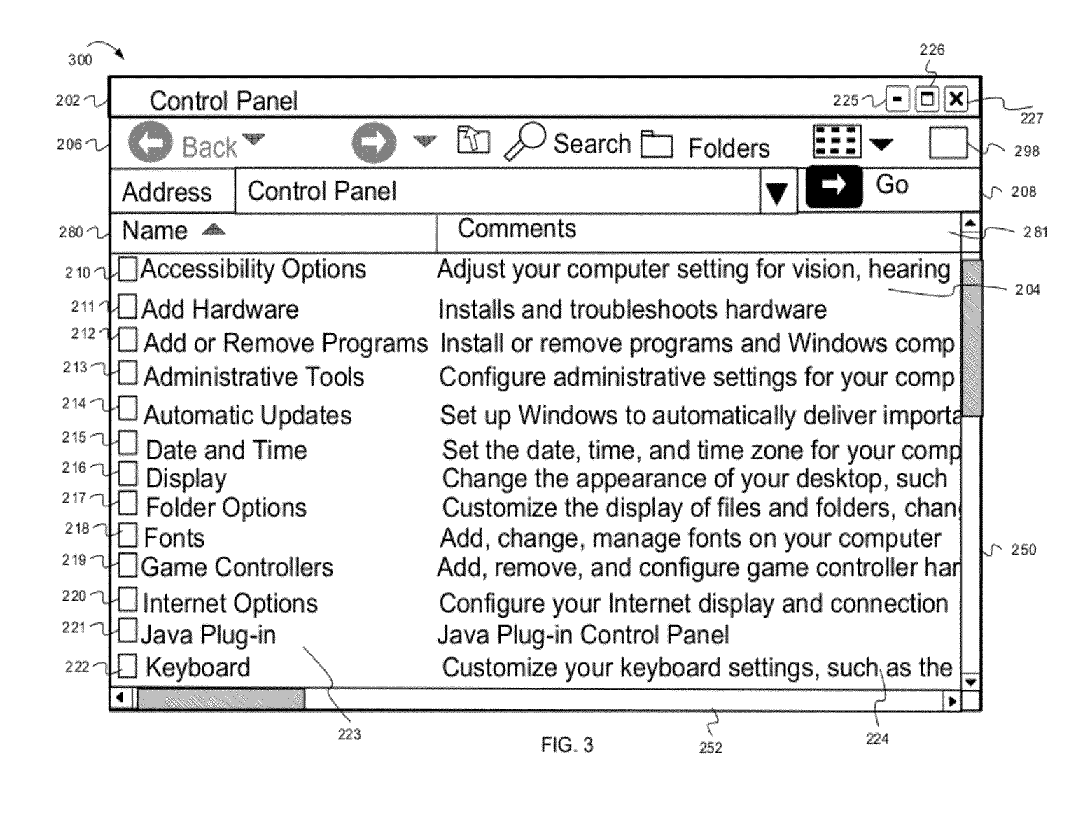

The display 102 can include any number of windows, wherein each window can have any number of elements. The windows can provide a graphical user interface for applications executing in the system 100. In this example, the display 102 includes a window A 118, a window B 120, and a window N 124. The window A 118 includes elements 126. The window B 120 includes elements 128. The window N 124 includes elements 132. The elements 126, the elements 128, and the elements 132 can include text, graphics, icons, buttons, controls, etc. The elements 126, the elements 128, and the elements 132 can include elements in the window frame (e.g., control buttons for minimizing and maximizing the window, title text, etc.) and elements in the content section within the window frame. More detailed examples of windows with different graphic manipulations are illustrated in FIGS. 3-8, which are described in more detail below.

In this example, multiple applications are executing in the processor 108. This execution can be serial, parallel, or partially in parallel. For example, assume that the processor 108 comprises multiple processors. Then different applications can be executing in different processors in parallel or at least partially in parallel. In this example, the applications executing in the processor 108 include an application A 130, an application B 132, an application N 134, and a graphics manager 116. While these applications are described as being software executing in the processor 108, in some other example embodiments, these applications can be hardware or a combination of hardware and firmware. In particular, any one of the functionalities performed by these applications may be partially (or entirely) implemented in hardware and/or in the processor 108. For example, the functionality may be implemented with an application specific integrated circuit, in logic implemented in the processor 108, in a co-processor on a peripheral device or card, etc. The application 130, the application B 132, and the application N 134 can be any type of applications that provide a graphically user interface (e.g., word processor applications, spreadsheet applications, an Internet web browser application, etc.). The graphics manager 116 can be software that controls the appearance and location of windows in a windows-based system in a graphical user interface (GUI). The graphics manager 116 can enable a user to close, open, maximize, minimize, and resize windows that are display content for different applications. In some example embodiments, the graphics manager 116 is part of the operating system of the system 100.

Execution of the application A 130 causes the display of the window A 118 with the elements 126 on the display 102. In particular, the processor 108 can send instructions to the graphics processor 104 through the I/O controller hub 106 to display the window A 118 on the display 102. Execution of the application B 132 causes the display of the window B 120 with the elements 128 on the display 102. In particular, the processor 108 can send instructions to the graphics processor 104 through the I/O controller hub 106 to display the window B 120 on the display 102. Execution of the application N 134 causes the display of the window N 124 with the elements 132 on the display 102. In particular, the processor 108 can send instructions to the graphics processor 104 through the I/O controller hub 106 to display the window N 124 on the display 102.

Also during operation, the graphics manager 116 can perform graphic manipulation of one or more elements in one or more windows being shown on the display 102. In some example embodiments, the graphic manipulation occurs independent of any involvement of the associated applications. In particular, the application that is graphically outputting the window has no knowledge of such graphic manipulation. However, prior to, during and after the graphic manipulation, a user can still interact with the application through the window using various input devices (e.g., keyboard selection, mouse inputs, etc.).

The graphics manager 116 can automatically perform the graphic manipulation based on a user-defined configuration. For example, when the window is to be displayed, the graphics manager 116 can review a user-defined configuration to graphically alter one or more elements of the window. The user-defined configuration enables a user to define a graphic manipulation configuration for elements and applications at a system or operating system level. This user-defined configuration can be performed prior to, during or after any instantiations of applications. For example, an operating system configuration control panel can enable a user to activate a user-defined graphics manipulation configuration, to deactivate the configuration or modify the configuration. The user can configure graphics manipulation configurations for individual elements or groups of elements. Additionally, the user can configure graphics manipulation configurations for individual applications or groups of applications. The configurations can be applied to individual users and groups on a system or the configurations can be made available to them to use. For example, these user-defined configurations can be defined for a given application, a given type of element, based on the behavior of related windows (parent, sibling, etc.), etc. Alternatively or in addition, a user can instruct the graphics manager 116 to perform the graphic manipulation (using one or more of the input device(s) 114). For example as further described below, existing buttons on the window frame (minimize and maximize buttons) can be overloaded to provide this additional function. To illustrate, the minimize button can be selected for three seconds to initiate a certain type of graphic manipulation. In another example, right click of the mouse within the window can provide a menu of additional graphic manipulations for this window (e.g., scaling, different types of distortion, perspective changes, rotating, making wider, making taller, modify colors, inverting colors, etc.).

In this example, the graphics manager 116 performs two different graphic manipulations of elements in two different windows, independent of operations or knowledge of the associated applications. In particular, the graphics manager 116 transmits a graphic manipulation 140 to modify at least some of the elements in the window A 118 (see point A showing the instruction being transmitted from the graphics manager 116 to the graphics processor 104 through the I/O controller hub 106). In response, the graphics processor 104 performs the requested update to at least some of the elements in the window A 118. The graphics manager 116 also transmits a graphic manipulation 142 to modify at least some of the elements in the window N 124 (see point B showing the instruction being transmitted from the graphics manager 116 to the graphics processor 104 through the I/O controller hub 106). In response, the graphics processor 104 performs the requested update to at least some of the elements in the window N 124. Examples of the different graphics manipulations of the elements in the windows are described below. Accordingly, some example embodiments remove the graphic manipulation of the applications from the application themselves. However, the applications can continue to execute normally—receiving user inputs, processing user inputs, updating elements in the window, etc.

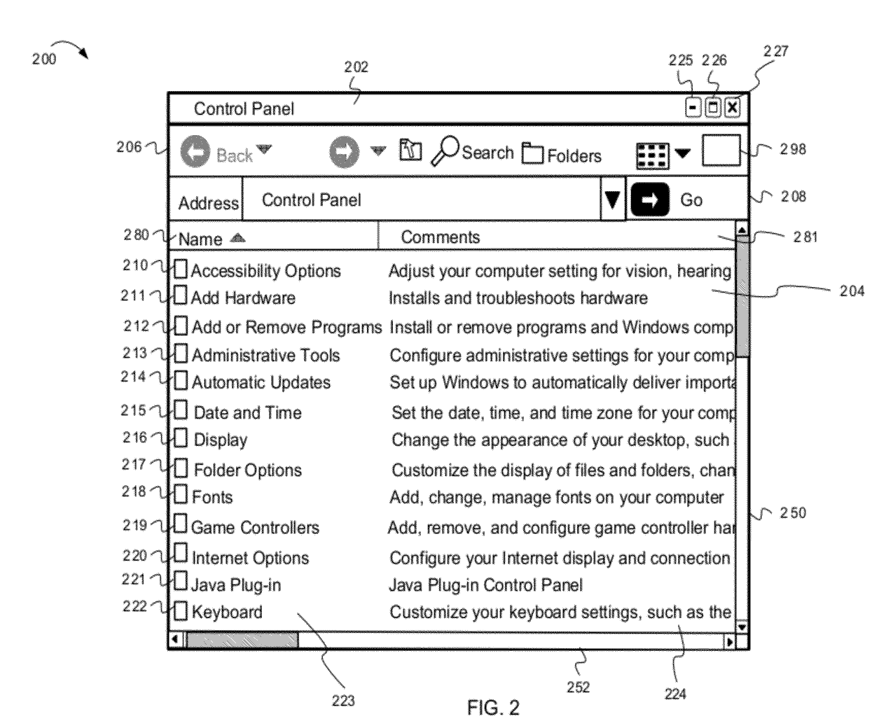

A number of different example screenshots of windows illustrating example graphic manipulations are now described. In particular, FIG. 2 depicts a screenshot of a window prior to graphic manipulation. FIGS. 3-8 depict screenshots of windows after graphic manipulations performed thereon. For the same components across FIGS. 2-8, a same reference number is used (e.g., frame section 202).

FIG. 2 depicts a screenshot of a window prior to a graphic manipulation, according to some example embodiments. FIG. 2 depicts a screenshot of a window 200 that provides a control panel for controlling different options of a computer. The window 200 includes a window frame section and a content section. The window frame section includes frame section 202 that includes the title “Control Panel” and three different control buttons (a minimize button 225, a maximize button 226, and a close button 227). The window frame section also includes a vertical scrollbar 250 and a horizontal scrollbar 252.

The content section includes a toolbar 206, an address section 208, and a data section 204. The data section 204 includes a left column title 280 (“Name”), a right column title 281 (“Comments”) and a number of entries (entries 210-222). Each of the entries 210-222 include a graphical icon on the left most side, text for the “Name” in a left column 223, and text for the “Comments” in a right column 224.

Different sections of different granularities of a window can be defined as elements that can be graphically manipulated. For example, an element can be considered the entire content section, wherein the content section can be scaled while the window frame section remains unchanged. An element can also be the entire window that includes both the window frame section and the content section. Elements can also be defined at finer granularity. For example, the toolbar 206 can be considered an element that is graphically manipulated independent of other parts of the window. In another example, individual parts of the toolbar 206 (e.g., back button and icon, search button and icon, folder button and icon, a graphical icon 298, etc.) can be considered an element that is graphically manipulated independent of other parts of the window. In another example, the data section 204 or parts of the data section 204 (e.g., the section having the entries 210-222, the left column title 280, the right column title 281, the left column—including the left column title 280 and the left column of the data section, the right column—including the right column title 281 and the right column of the data section, etc.) can be considered the element that is graphically manipulated independent of other parts of the window. In another example, a certain type of data (e.g., all text, all the graphical icons, etc.) across multiple sections of the window can be considered the element that is graphically manipulated independent of other parts of the window.

FIG. 3 depicts a screenshot of the window of FIG. 2 after a graphic manipulation wherein the window is scaled to an enlarged size, according to some example embodiments. In particular, FIG. 3 depicts a screenshot of a window 300 wherein the entire window is considered the element that is graphically manipulated. In this example, the window 200 is enlarged to become the window 300. This operation to scale the window 300 can be performed a number of different ways. In some example embodiments, the minimize button 225 and/or the maximize button 226 are overloaded. Accordingly, the user can select and hold (e.g., three seconds) either the minimize button 225 or the maximize button 226. In response, the graphics manager 116 causes one or both buttons to change colors to indicate that the window is to be scaled. The graphics manager 116 can also place scaling anchors dots around the window (e.g. four different corners). The user can then scale the window as they like by selecting and dragging sides, corners, etc. of the window 300. The user can select the minimize button 225 or the maximize button 226 to end the scaling mode. In response, the graphics manager 116 removes the color change for the buttons and the scaling anchor dots from around the window. In some other example embodiments (instead of the scaling anchor dots), the scaling control can be limited to one corner (e.g., bottom right window corner). The user can adjust horizontally and/or vertically. After the user releases the selection from the scaling control, scaling mode automatically ends (no need to select the minimize button 225 or the maximize button 226 to end). This independent scaling of elements/windows can have a big impact on accessibility of applications (e.g., older generations, elderly, persons with visual impairments, etc.).

There are many alternatives to using the minimize and maximize buttons for initiating graphic manipulation. For example, the scaling can be adjusted via an application control panel, task manager process or windows start bar (e.g., right mouse click on the start bar application or right click on the task manager process and select a type of graphic manipulation from a menu (e.g., scaling, distort, show perspective, rotate, make wider, make taller, modify colors, invert colors, etc.)). These different inputs by the user are received by the task manager 116 and not the applications associated with the windows. The task manager 116 can then process these inputs for graphic manipulation, without the applications.

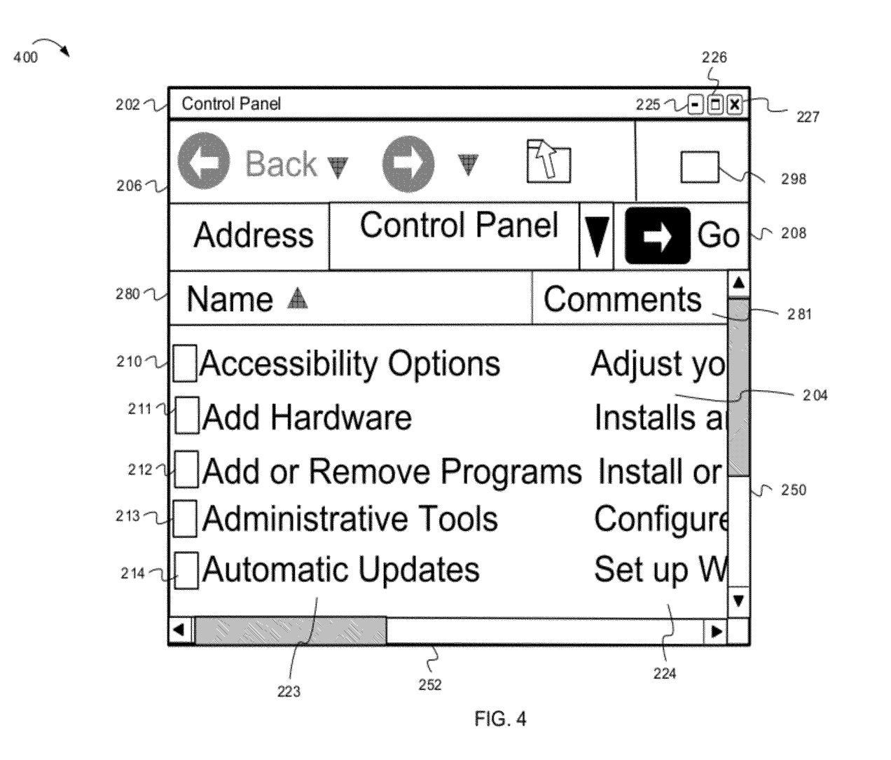

FIG. 4 depicts a screenshot of the window of FIG. 2 after a graphic manipulation wherein the window size remains the same but contents within the window frame are scaled to an enlarged size, according to some example embodiments. In particular, FIG. 4 depicts a screenshot of a window 400 wherein the element being graphically manipulated includes all parts of the window in the content section along with the vertical scrollbar 250 and the horizontal scrollbar 252. In this graphic manipulation, the size of the window 400 is the same as the size of the window 200. Also, the size of a part of the window frame section (including the frame section 202 that includes the title “Control Panel” and three different control buttons (a minimize button 225, a maximize button 226, and a close button 227) for the window 200 and the window 400 remains the same. The data in the content section within the window frame is scaled to an enlarged size. The window 400 follows normal application behavior. For example, the window 400 maintains the graphical icon 298 is in the top, rightmost position, and the “Go” text in the address section 208 in the rightmost position. Also, the elevator bars for the vertical scrollbar 250 and the horizontal scrollbar 252 are scaled to the enlarged size, wherein their lengths are proportioned correctly for the window size. Alternatively, the window 400 can be scaled such that the window 200 and the window 400 remain the same, such that all parts of the window are scaled (including the frame section 202).

This graphic manipulation can be initiated by the user via an application control panel, task manager process or windows start bar (e.g., right mouse click on the start bar application or right click on the task manager process and select a type of graphic manipulation from a menu to enlarge the content while keeping the window size constant. This selection by the user can be received by the task manager 116 and not the application associated with the window. The task manager 116 can then process these inputs for graphic manipulation, without the applications.

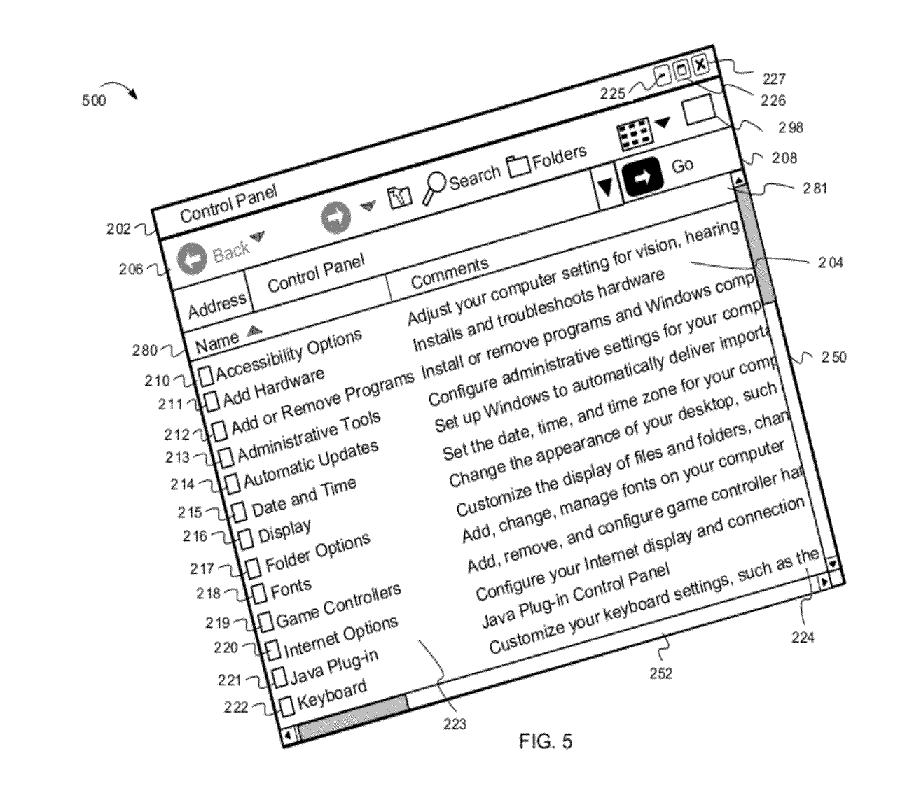

FIG. 5 depicts a screenshot of the window of FIG. 2 after a graphic manipulation wherein the window is rotated, according to some example embodiments. In particular, FIG. 5 depicts a screenshot of a window 500 wherein the element being graphically manipulated includes the entire window and the contents therein. In this example, there is no scaling but a rotation. The rotation can be any number of degrees (0° to 360°). Also, the rotation can be in either direction.

This graphic manipulation can be initiated by the user via selection of overloaded buttons (see description of FIG. 3 above), an application control panel, task manager process or windows start bar (e.g., right mouse click on the start bar application or right click on the task manager process and select a type of graphic manipulation from a menu to rotate the window. Similar to FIG. 3 above, the graphics manager 116 can place anchors dots around the window (e.g. four different corners). The user can then rotate the window as they like by selecting a corner and rotating of the window 300. These inputs by the user can be received by the task manager 116 and not the application associated with the window. The task manager 116 can then process these inputs for graphic manipulation, without the applications.

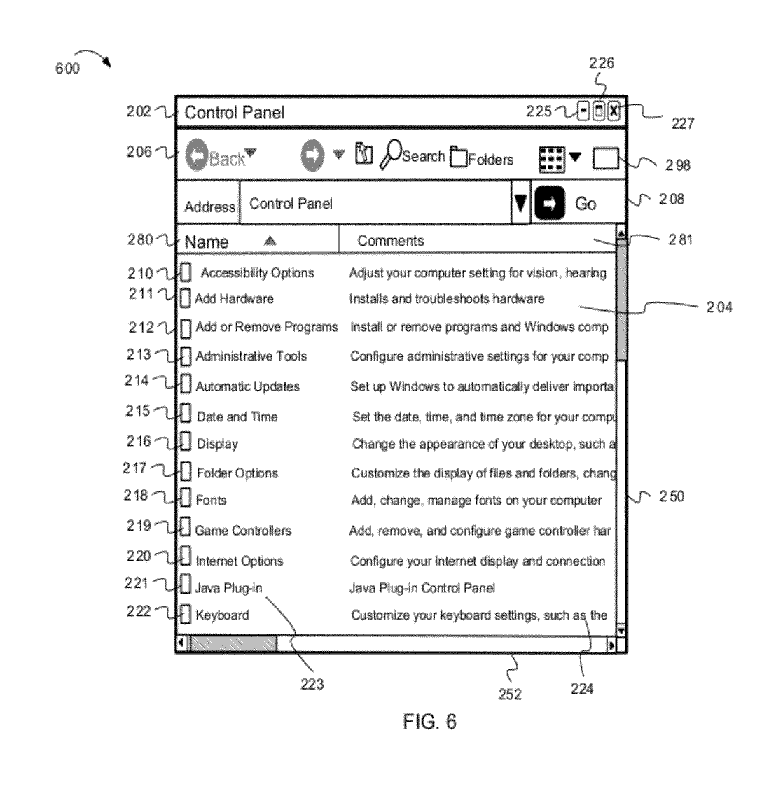

FIG. 6 depicts a screenshot of the window of FIG. 2 after a graphic manipulation wherein the window is made taller and thinner, according to some example embodiments. In particular, FIG. 6 depicts a screenshot of a window 600 wherein the element being graphically manipulated includes the entire window and the contents therein. In this example, the window 600 is expanded lengthwise and contracted widthwise. The window 600 can be expanded or contracted either lengthwise or widthwise. In some other example embodiments, the windows can be just expanded or contracted lengthwise. In some other example embodiments, the windows can be just expanded or contracted widthwise.

This graphic manipulation can be initiated by the user via selection of overloaded buttons (see description of FIG. 3 above), an application control panel, task manager process or windows start bar (e.g., right mouse click on the start bar application or right click on the task manager process and select a type of graphic manipulation from a menu. Similar to FIG. 3 above, the graphics manager 116 can place anchors dots around the window (e.g. four different corners). The user can then adjust the width and height of the window as they like by selecting and dragging sides, corners, etc. of the window 600. These inputs by the user can be received by the task manager 116 and not the application associated with the window. The task manager 116 can then process these inputs for graphic manipulation, without the applications.

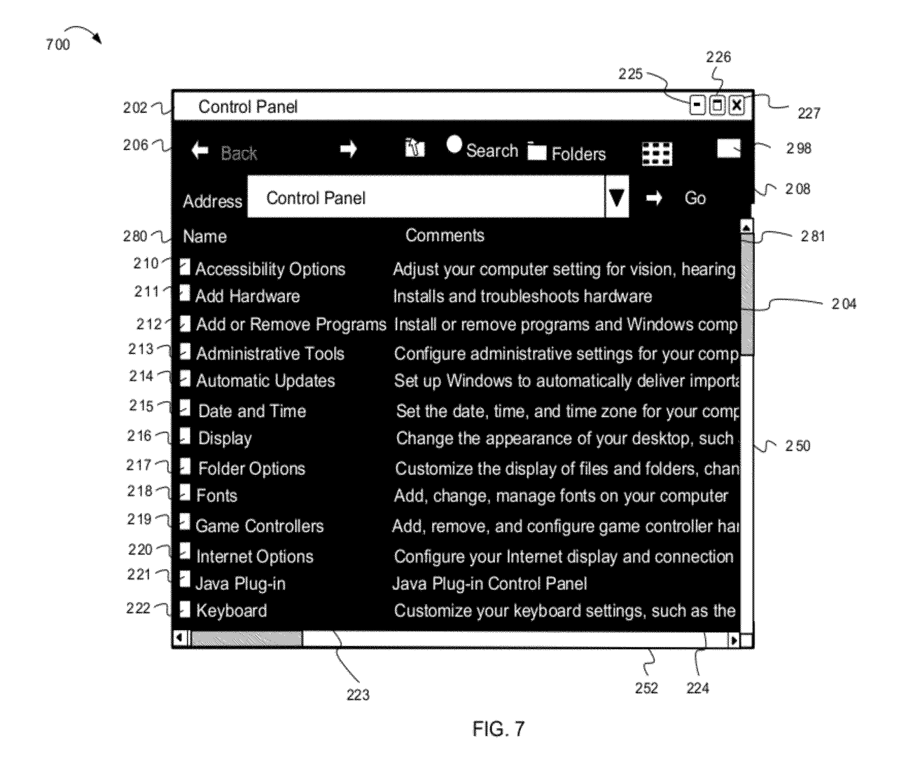

FIG. 7 depicts a screenshot of the window of FIG. 2 after a graphic manipulation wherein the colors in the window are inverted, according to some example embodiments. In particular, FIG. 7 depicts a screenshot of a window 700 wherein the colors in both the window frame section and content section are inverted. For example, the text is changed from black to white, and the background is changed from white to black. In some example embodiments, colors in only portions of the window are inverted. For example, only colors in the data section 204 are inverted, while colors in the other portions of the window 700 remain the same. In some example embodiments, colors of only certain types of data are inverted. For example, only the text and associated background are inverted.

This graphic manipulation can be initiated by the user via an application control panel, task manager process or windows start bar (e.g., right mouse click on the start bar application or right click on the task manager process and select a type of graphic manipulation from a menu to inverts the colors of the window). These inputs by the user can be received by the task manager 116 and not the application associated with the window. The task manager 116 can then process these inputs for graphic manipulation, without the applications.

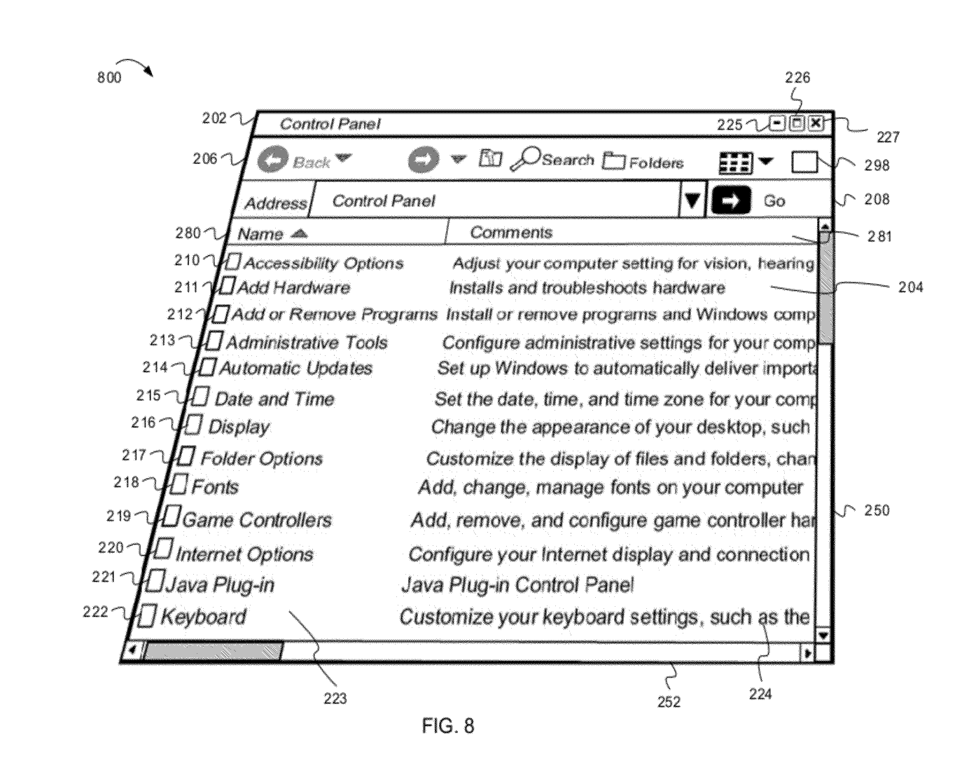

FIG. 8 depicts a screenshot of the window of FIG. 2 after a graphic manipulation wherein the window is tilted backwards, according to some example embodiments. In particular, FIG. 8 depicts a screenshot of a window 800, wherein the window 200 of FIG. 2 has been laid back along a horizontal axis along the bottom of the window. In some example embodiments, the window 800 can be rotated in either direction along a horizontal axis along the bottom of the window or the top of the window. Alternatively or in addition, the window 800 can be rotated along a vertical axis along the right side or left side of the window.

This graphic manipulation can be initiated by the user via selection of overloaded buttons (see description of FIG. 3 above), an application control panel, task manager process or windows start bar (e.g., right mouse click on the start bar application or right click on the task manager process and select a type of graphic manipulation from a menu. Similar to FIG. 3 above, the graphics manager 116 can place anchors dots around the window (e.g. four different corners). The user can then adjust the angle of the window 800. These inputs by the user can be received by the task manager 116 and not the application associated with the window. The task manager 116 can then process these inputs for graphic manipulation, without the applications.

There can be other types of graphic manipulations not illustrated in FIGS. 3-8. For example, the graphics manager 116 can be used to stack the windows such that a portion of each window is shown. In some example embodiments, the graphics manipulation can include adding and removing of three dimensional (3D) content from the windows. For example, in a three dimensional environment with a left-eye 3D channel and a right-eight 3D channel, the graphics manager 116 can draw elements independently to one or both channels with a 3D effect to achieve a 3D sensation. To illustrate, a button element can appear to be popping out of the display surface toward the user. In another illustration, the icon elements can appear to be recessed behind the display surface away from the user.

The graphic manipulation can also include the removing of 3D content. In particular, the graphics manager 116 can remove the 3D effect applied to an element and can stop drawing elements to different 3D channels that cause a 3D sensation. Accordingly, the graphics manager 116 can enable 3D effects on a per element and/or a per application basis.

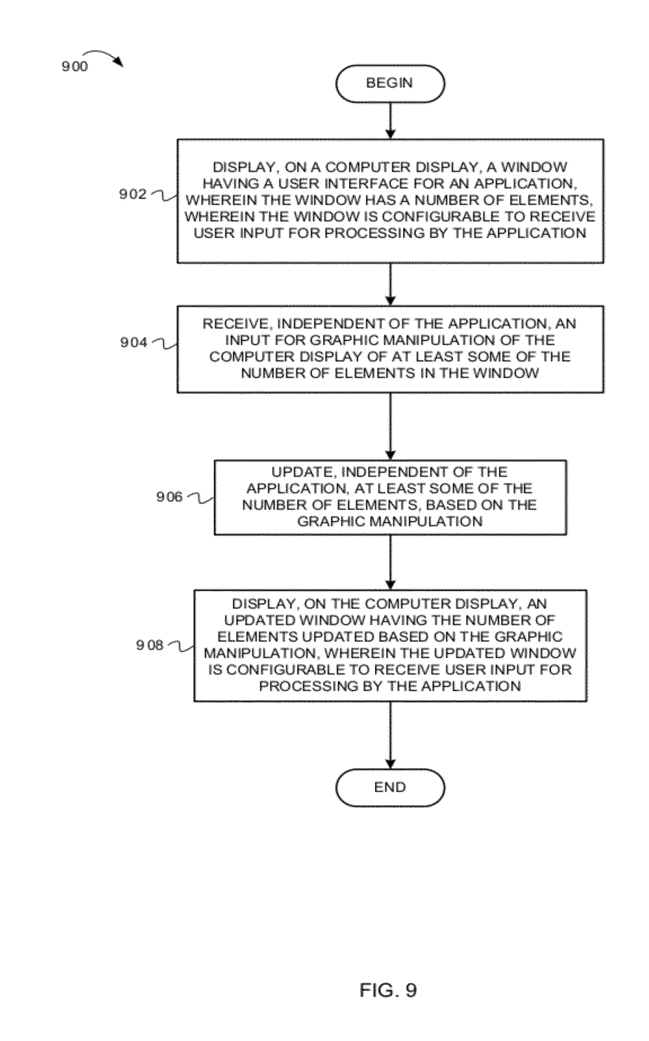

A flowchart of operations, according to some example embodiments, is now described. In particular, FIG. 9 depicts a flowchart to perform graphic manipulation of elements in windows displaying graphic output of applications, independent of the applications, according to some example embodiments. The operations of the flowchart 900 are described with reference to FIG. 1. The operations of the flowchart 900 start at block 902.

At block 902, the graphics processor 104 displays, on a computer display, a window having a user interface for an application. The window has a number of elements. Also, the window is configurable to receive user input for processing by the application. With reference to FIG. 1, the graphics processor 104 displays the window A 118, the window B 120, and the window N 124 on the display 102. The window A 118 includes elements 126. The window B 120 includes elements 128. The window N 124 includes elements 132. The elements 126, the elements 128, and the elements 132 can include text, graphics, icons, buttons, controls, etc. The elements 126, the elements 128, and the elements 132 can include elements in the window frame (e.g., control buttons for minimizing and maximizing the window, title text, etc.) and elements in the content section within the window frame. The operations of the flowchart 900 continue at block 904.

At block 904, the graphics manager 116 receives, independent of the applications, an input for graphic manipulation of the computer display of at least some of the number of elements in the window. With reference to FIG. 1, the graphics manager 116 receives the input for graphic manipulation of at least some of the elements of one of the window A 118, the window B 120, and the window N 124. As described above, this input can be received from a user through one of the input device(s) 114. The graphics manager 116 receives this input for graphic manipulation, independent of the associated application. The operations of the flowchart 900 continue at block 906.

At block 906, the graphics manager 116 updates, independent of the application, at least some of the number of elements, based on the graphic manipulation. With reference to FIG. 1, the graphics manager 116 updates at least some of the elements of one of the window A 118, the window B 120, and the window N 124. The graphics manipulation can scale, distort, show perspective, rotate, make wider, make taller, modify colors, invert colors, add/remove 3D content, etc. based on the input from the user.

At block 908, the graphics processor 104 displays, on the computer display, an updated window having the number of elements updated based on the graphic manipulation. The associated application can receive user input through the window for processing by the application prior to, during and after the updates to the number of elements therein. The operations of the flowchart 900 are complete.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for graphic manipulation as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
displaying, on a computer display, a window having a user interface for an application, the window having a number of elements, the elements comprising at least one of text, a graphical icon, and input control, wherein the window is configurable to receive user input for processing by the application;
receiving, independent of the application, an input for graphic manipulation of the computer display of at least some of the number of elements in the window;
updating, independent of the application, the at least some of the number of elements, based on the graphic manipulation; and
displaying, on the computer display, an updated window having the number of elements updated based on the graphic manipulation, wherein the updated window is configurable to receive user input for processing by the application.

2. The method of claim 1, wherein the graphic manipulation is used for subsequent windows for subsequent instantiations of the application.

3. The method of claim 1, further comprising displaying, on the computer display, at least one child element whose parent is the window, wherein the at least one child element is updated based on the graphic manipulation of the at least some of the number of elements in the window.

4. The method of claim 3, wherein the at least one child element comprises a different window that was created in response to an operation executed by the application.

5. The method of claim 1, wherein updating the at least some of the elements comprises updating an element that is part of a frame of the window.

6. The method of claim 1, wherein updating the at least some of the elements comprises updating an element that is within a content section inside a frame of the window such that the at least some of the elements does not include elements that are part of the frame of the window.

7. The method of claim 1, wherein the graphic manipulation comprises scaling.

8. An apparatus comprising:
a display;
a processor;
an application operable on the processor, the application configured to execute to create a window having a user interface for display on the display;
a graphics processor communicatively coupled to the processor and the display, the graphics processor configured to, receive the window from the application; and
display the window on the display; and
a graphics manager operable on the processor, the graphics manager configured to
receive, independent of the application, an input for graphic manipulation of at least some of the elements of the window;
update, independent of the application, the at least some of the elements based on the graphic manipulation to create updated elements; and
transmit, independent of the application and to the graphics processor, the updated elements;
wherein the graphics processor is configured to, independent of the application, receive the updated elements and to update the window on the display using the updated elements to create an updated window, wherein the updated window is configurable to receive user input for processing by the application.

9. The apparatus of claim 8, wherein the graphic manipulation is used for subsequent windows for subsequent instantiations of the application.

10. The apparatus of claim 8, wherein the graphics manager is to cause display, on the computer display, at least one child element whose parent is the window, wherein the at least one child element is updated based on the graphic manipulation of the at least some of the number of elements in the window.

11. The apparatus of claim 10, wherein the at least one child element comprises a different window that was created in response to an operation executed by the application.

12. The apparatus of claim 8, wherein the update to the at least some of the elements comprises an update to an element that is part of a frame of the window.

13. The apparatus of claim 8, wherein the update to the at least some of the elements comprises an update to an element that is within a content section inside a frame of the window such that the at least some of the elements does not include elements that are part of the frame of the window.

14. The apparatus of claim 8, wherein the graphic manipulation comprises scaling.

15. A computer program product for graphic manipulation of a window on a computer display, the computer program product comprising:
a computer readable storage medium having computer usable program code embodied therewith, the computer usable program code comprising a computer usable program code configured to:
display, on the computer display, the window having a user interface for an application, the window having a number of elements, the elements comprising at least one of text, a graphical icon, and input control, wherein the window is configurable to receive user input for processing by the application;
receive, independent of the application, an input for the graphic manipulation of the computer display of at least some of the number of elements in the window;
update, independent of the application, the at least some of the number of elements, based on the graphic manipulation; and
display, on the computer display, an updated window having the number of elements updated based on the graphic manipulation, wherein the updated window is configurable to receive user input for processing by the application.

16. The computer program product of claim 15, wherein the graphic manipulation is used for subsequent windows for subsequent instantiations of the application.

17. The computer program product of claim 15, wherein the computer usable program code is configured to display, on the computer display, at least one child element whose parent is the window, wherein the at least one child element is updated based on the graphic manipulation of the at least some of the number of elements in the window.

18. The computer program product of claim 17, wherein the at least one child element comprises a different window that was created in response to an operation executed by the application.

19. The computer program product of claim 15, wherein the update of the at least some of the elements comprises an update to an element that is part of a frame of the window.

20. The computer program product of claim 15, wherein the update to the at least some of the elements comprises an update to an element that is within a content section inside a frame of the window such that the at least some of the elements does not include elements that are part of the frame of the window.
